(19) United States
(12) Patent Application Publication
(10) Pub. No.: US 2003/0070013 A1
(43) Pub. Date: Apr. 10, 2003

(54) Method and apparatus for reducing power consumption in a digital processor

(76) Inventor: Daniel Hansson, London (GB)

Correspondence Address: GAZDZINSKI & ASSOCIATES, Suite A232, 3914 Murphy Canyon Road, San Diego, CA, 92123, US

(21) Appl. No.: 10/083,057

(22) Filed: Oct. 25, 2001

Related U.S. Application Data
(60) Provisional application No. 60/244,071, filed on Oct. 27, 2000.

(51) Int. Cl. G06F 3/00

(52) U.S. Cl. 710/59

(57) ABSTRACT

A method and apparatus for reducing power consumption within a pipelined processor. In one embodiment, the method of the invention comprises defining an instruction which invokes a “sleep mode” within the processor and pipeline; inserting the instruction into the pipeline; decoding and executing the instruction, stalling the pipeline in response to the sleep mode instruction; disabling memory in response to the sleep mode instruction; and awaking the core from sleep mode based on the occurrence of a predetermined event. Methods for structuring core pipeline logic and extension instructions to reduce core power consumption under various conditions are described. Methods and apparatus for synthesizing logic implementing the aforementioned methodology are also disclosed.

### PRIORITY

This application claims priority benefit to U.S. provisional patent application Serial No. 60/244,071 filed Oct. 27, 2000 entitled “Method And Apparatus For Reducing Power Consumption With A Digital Processor Using Sleep Modes” which is incorporated herein by reference in its entirety.

### RELATED APPLICATIONS

This application is related to co-pending U.S. patent application Ser. No. 09/418,663 filed Oct. 14, 1999 entitled “Method and Apparatus for Managing the Configuration and Functionality of a Semiconductor Design”, which claims priority benefit of U.S. provisional patent application Serial No. 60/104,271 filed Oct. 14, 1998, of the same title.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates to the field of integrated circuit design, specifically to (i) power reduction techniques; and (ii) the use of a hardware description language (HDL) for implementing related instructions and control; in a pipelined central processing unit (CPU) or user-customizable microprocessor.

2. Description of Related Technology

RISC (or reduced instruction set computer) processors are well known in the computing arts. RISC processors generally have the fundamental characteristic of utilizing a substantially reduced instruction set as compared to non-RISC (commonly known as “CISC”) processors. Typically, RISC processor machine instructions are not all micro-coded, but rather may be executed immediately without decoding, thereby affording significant economies in terms of processing speed. This “streamlined” instruction handling capability furthermore allows greater simplicity in the design of the processor (as compared to non-RISC devices), thereby allowing smaller silicon and reduced cost of fabrication.

RISC processors are also typically characterized by (i) load/store memory architecture (i.e., only the load and store instructions have access to memory; other instructions operate via internal registers within the processor); (ii) unity of processor and compiler; and (iii) pipelining.

A significant concern in RISC processors (and for that matter, most every integrated circuit) is power consumption and dissipation. There are generally two sources of power dissipation in integrated circuits: dynamic power and static power. The power that is consumed only when a signal toggles (i.e. changes from 0 to 1 or from 1 to 0) is defined as dynamic power consumption. Toggles are also commonly referred to as switching activity. The much smaller amount of power that is consumed in a cell (e.g. a gate or flipflop) when there is no switching activity is called static power consumption or cell leakage power. In a modern CMOS technology, static power consumption represents less than 1% of the total power consumption and can thus be ignored in most applications.

Dynamic power in turn consists of two components: net switching power and cell internal power. Net switching power is the power consumed on a net when the signal it is carrying is toggling. Net switching power is proportionally dependent on the switching activity, the net load and the squared voltage. The net load is the capacitive load of the net itself plus the capacitive loads of all input pins of the cells connected to the net. Thus the net load is dependent on its length (its load) and its fanout (the load of connected cells). Net switching power can also be defined as only the net load if the capacitive load of the input pins is added to the cell internal power. The total power consumption will be the same since both definitions include the same loads in aggregate. The aforementioned conditions are frequently expressed by Eqn. 1:

P=CV²f (Eqn. 1)

where:

P=power;

C=capacitance driven by a specific gate;

V=power supply voltage to the gate; and

f=switching frequency.

Cell internal power is the power consumed when one or more cell input signals toggle. During the transition time when an input or an output signal changes state, both the pull-down and pull-up transistor will be open and a large current will flow through the cell. This is also often called short circuit power. The transition time depends on the chosen technology, but the number of times the transition occurs depends on the switching activity. Cell internal power is proportionally dependent on the switching activity and the squared voltage. Voltage is generally the most important parameter for determining the total power consumption as it is the only squared term in the power equation. Therefore, the choice of technology (where the voltage is defined) is the most important factor that determines total power consumption.

HDL specifications typically do not permit designers to set the operating voltage level within the target design. Instead, HDL permits designers to address the second and third most important parameter, switching activity and net load. The product of these two parameters affects the power. The principle of most power reduction strategies at the HDL level is to add logic that reduces the switching activity and thereby the power consumption.

Ignoring static power, if the design does not toggle, it does not consume power even when there is a large total load present. Similarly, even if a net is toggling at a high frequency it might consume comparatively little power if the net load is small. The most power consuming nets of a design are those in the clock tree, because they toggle at a high frequency and have a high load since they are connected to all the flip-flops in the design. Power is saved by reducing the product of net load and switching activity power. This can be achieved by working within the HDL framework and evaluating the effects of different design topologies. The ideal goal is to remove all unnecessary toggles that do not contribute to the functionality of the design. Such power saving approaches transcend the specific technology used to build the component. Some tools, e.g. Synopsys Power Compiler™, help to do this directly on the netlist.

Another potentially useful power saving feature for digital processors relates to the use of Gray codes. Gray codes (also called cyclical or progressive codes) have historically been useful in mechanical encoders since a slight change in location only affects one bit. However, these same codes offer other benefits well understood to one skilled in the art including being hazard-free for logic races and other conditions that could give rise to faulty operation of the circuit. The use of such Gray codes also have important advantages in power saving designs. Because only one bit changes per state change, there is a minimal number of circuit elements involved in switching per input change. This in turn reduces the amount of dynamic power by limiting the number of switched nodes toggled per clock change. Using a typical binary code, up to n bits could change, with up to n subnets changing per clock or input change.

However, while somewhat effective methods have been developed for reducing power consumption due to switching within the processor based on choice of technology and manipulation of the netlist, there is presently no effective and efficient method or apparatus for the temporally-controlled reduction of power consumption within a processor, such as during periods when the pipeline and/or memory array is not required to operate. Furthermore, such technology- or netlist-based prior art power reduction solutions are generally not optimized for extensible architectures (i.e., those employing one or more extension instructions within the processor instruction set), in that these techniques are decoupled from the presence (or absence of) extension instructions and any supporting architecture. Ideally, power reduction techniques employed on extensible processors could be coupled to the extensions, such that as more extensions are added, a proportionate amount of power savings would be reflected.

Based on the foregoing, there is a need for an improved method and apparatus for reducing power consumption within a digital processor, especially during periods of inactivity within the pipeline and other processor components. Such method and apparatus would be readily implemented in a variety of different processor design configurations, would be compatible with other existing power reductions techniques (such as the manipulation of the netlist as previously described), and would provide appreciable reductions in processor power consumption (and potentially heat generation). These methods and apparatus would also be compatible with, and provide reduction in power consumption relating to, extension instructions present in the core architecture.

### SUMMARY OF THE INVENTION

The present invention satisfies the aforementioned needs by providing an improved method and apparatus for reducing power consumption with a digital processor using sleep modes.

In a first aspect of the invention, an improved method for reducing power consumption within a digital processor is disclosed. In one embodiment, the method comprises first defining an instruction which invokes a “sleep mode” within the processor and its pipeline; inserting the instruction into the pipeline during operation of the processor; decoding and executing the instruction; stalling the pipeline in response to the sleep mode instruction; disabling processor memory in response to the sleep mode instruction; and awaking the core from sleep mode based on the occurrence of a predetermined event. In this fashion, the programmer can selectively shut down portions of the processor under certain circumstances, thereby significantly reducing power consumption during such periods, and reducing the power consumption of the processor as a whole.

In another embodiment, the aforementioned sleep mode methodology is combined with a pipeline low power enable configuration which stalls unnecessary data in the pipeline, thereby conserving power within the processor. The method comprises providing a logic circuit adapted for detection of a predetermined condition of the data within the pipeline; inserting data into the pipeline; detecting, using the aforementioned logic circuit that the predetermined condition exists with respect to certain of the data; invoking a sleep mode within the pipeline in response to the detected condition; and restarting the pipeline when the condition no longer exists.

In yet another embodiment, Gray coding is used in the design of the pipeline logic and in conjunction with the aforementioned sleep mode technique to further reduce power consumption. Such Gray coding comprises forming a binary sequence of data in which only one bit changes at any given time. By restricting the processor design such that only one bit changes at the time during certain operating modes, power consumption is reduced.

In a second aspect of the invention, an improved instruction format for invoking the aforementioned “sleep mode” is disclosed. In one embodiment, the format comprises (i) a base instruction element or kernel, (ii) one or more operand bits or fields, and (iii) one or more flag bits or fields. The instruction is coded within the base instruction set of the processor.

In a third aspect of the invention, an improved method of synthesizing the design of an integrated circuit incorporating the aforementioned sleep mode functionality is disclosed. In one exemplary embodiment, the method comprises obtaining user input regarding the design configuration; creating a customized HDL functional block description based on the user input and existing libraries of functions; determining a design hierarchy based on the user input and existing libraries; running a makefile to create the structural HDL and script; running the script to create a makefile for the simulator and a synthesis script; and synthesizing and/or simulating the design from the simulation makefile or synthesis script, respectively.

In a fourth aspect of the invention, an improved computer program useful for synthesizing processor designs and embodying the aforementioned sleep mode functionality is disclosed. In one exemplary embodiment, the computer program comprises an object code representation stored on the magnetic storage device of a microcomputer, and adapted to run on the central processing unit thereof. The computer program further comprises an interactive, menu-driven graphical user interface (GUI), thereby facilitating ease of use.

In a fifth aspect of the invention, an improved apparatus for running the aforementioned computer program used for synthesizing gate logic associated with the aforementioned sleep mode functionality is disclosed. In one exemplary embodiment, the system comprises a stand-alone microcomputer system having a display, central processing unit, data storage device(s), and input device.

In a sixth aspect of the invention, an improved processor architecture utilizing the foregoing sleep mode functionality and instruction format is disclosed. In one exemplary embodiment, the processor comprises a reduced instruction set computer (RISC) having a four stage pipeline comprising instruction fetch, decode, execute, and writeback stages and an instruction set comprising at least one SLEEP instruction, which is used in a delay slot of the pipeline of the processor.

### BRIEF DESCRIPTION OF THE DRAWINGS

FIG. 1a is a graphical representation of a first embodiment (“base case”) of the SLEEP instruction format according to the present invention.

FIG. 1b is a graphical representation of a second embodiment of the SLEEP instruction format according to the present invention, having associated operand and flag fields.

FIG. 1c is a graphical representation of the debug register of the processor core, including ZZ and ED fields.

FIG. 2 is logical flow diagram illustrating a first embodiment of the method of reducing power consumption within a digital processor according to the present invention.

FIGS. 3a and 3b are schematic diagrams illustrating exemplary embodiments of the logic used to implement the sleep mode functionality according to the present invention.

FIG. 4a is a functional block diagram illustrating the relationship of the core clock module to other components within the processor core.

FIGS. 4b and 4c are schematic diagrams illustrating exemplary clock module gate logic for the instances where clock gating is selected and not selected during core build, respectively.

FIGS. 4d-4f are schematic diagrams illustrating exemplary embodiments of the logic used to implement the clock gating functionality according to the present invention.

FIG. 5 is logical flow diagram illustrating a second embodiment of the method of reducing power consumption within a digital processor by stalling the pipeline in response to the detection of invalid data.

FIG. 6 is a logical flow diagram illustrating the generalized methodology of synthesizing processor logic which incorporates the sleep mode functionality of the present invention.

FIG. 7 is a block diagram of a pipelined processor design incorporating the sleep mode functionality of the present invention.

FIG. 8 is a functional block diagram of one exemplary embodiment of a computer system useful for synthesizing logic gate logic implementing the aforementioned sleep mode functionality within a processor device.

### DETAILED DESCRIPTION

Reference is now made to the drawings wherein like numerals refer to like parts throughout.

As used herein, the term “processor” is meant to include any integrated circuit or other electronic device capable of performing an operation on at least one instruction word including, without limitation, reduced instruction set core (RISC) processors such as the ARC user-configurable core manufactured by the Assignee hereof, central processing units (CPUs), and digital signal processors (DSPs). The hardware of such devices may be integrated onto a single piece of silicon (“die”), or distributed among two or more die. Furthermore, various functional aspects of the processor may be implemented solely as software or firmware associated with the processor.

Additionally, it will be recognized by those of ordinary skill in the art that the term “stage” as used herein refers to various successive stages within a pipelined processor; i.e., stage 1 refers to the first pipelined stage, stage 2 to the second pipelined stage, and so forth.

As used herein, the term “toggle” refers to the number of times a signal changes from 0 to 1 or from 1 to 0. If a signal changes from 0 to 1 it has toggled once. If it changes back to 0 again it has toggled twice. Thus, a clock signal generally toggles twice per clock period, and all other signals toggle at a maximum of once per clock period (except if the signals are generated on both clock edges, etc.).

It is also noted that while portions of the following description are cast in terms of VHSIC hardware description language (VHDL), other hardware description languages such as Verilog® may be used to describe various embodiments of the invention with equal success. Furthermore, while an exemplary Synopsys® synthesis engine such as the Design Compiler 1999.05 (DC99) is used to synthesize the various embodiments set forth herein, other synthesis engines such as Buildgates® available from, inter alia, Cadence Design Systems, Inc., may be used. IEEE std. 1076.3-1997, IEEE Standard VHDL Synthesis Packages, describe an industry-accepted language for specifying a Hardware Definition Language-based design and the synthesis capabilities that may be expected to be available to one of ordinary skill in the art.

Appendix I hereto provides relevant portions of the HDL code relating to the various aspects of the invention.

Sleep Mode

In one aspect, the present invention comprises a “sleep mode” wherein the core pipeline (and optionally memory devices associated with the core) is shut down to conserve power. In one embodiment, the sleep mode is initiated using a SLEEP instruction which comprises an assembly language instruction of the type well known in the art which is placed within an instruction slot in the processor pipeline. The SLEEP instruction, when executed by the processor, allows the processor core to go into a sleep mode which, inter alia, stalls the processor pipeline until an interrupt or designated restart event occurs, thereby reducing power consumption. As used herein, the term “interrupt” refers to a state wherein the processor causes programmatic control to be transferred to an interrupt service routine, whereas the term “restart” refers to that condition when the processor is re-enabled after having been halted. These factors may include conclusion of a wait state time needed for external memory access or other timing related issues. Less power is consumed by the core during sleep mode operation under the present invention because (i) the pipeline ceases to change, and (ii) the random access memory (RAM) device(s) can be disabled. Specifically, by stalling the pipeline and disabling the memory, cell switching activity within the processor is reduced. Such switching activity includes all nets that are connected to the pipeline such as major processor busses, and toggling of memory access circuits. This accordingly represents a significant core power reduction over prior art techniques based purely on netlist management as previously described.

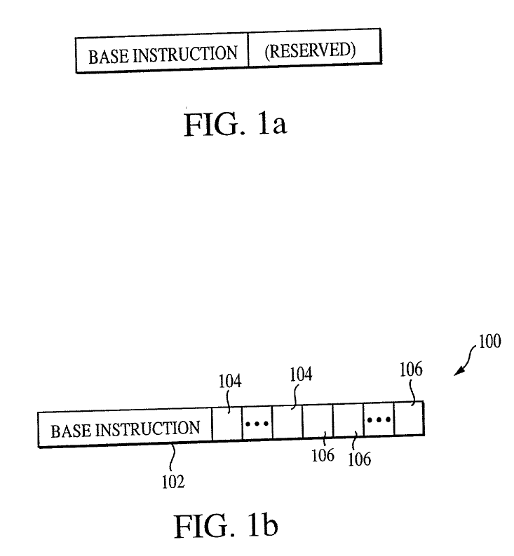

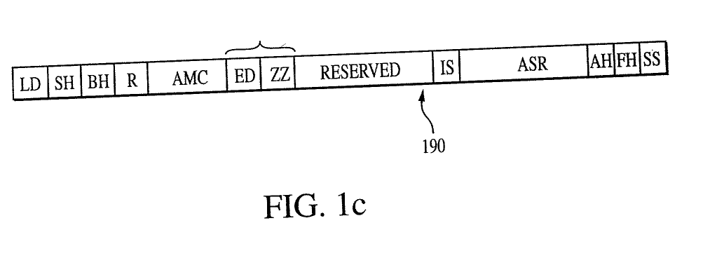

One embodiment of the SLEEP instruction of the invention (FIG. 1a) is configured only to be detected in pipeline stage 2, and has no associated options or operands. Such embodiment represents the “baseline” functionality. It will be appreciated, however, that other configurations which utilize operands and/or flags may be employed with equal success, depending on the required attributes for the particular core design. For example, FIG. 1b illustrates an exemplary embodiment of such an alternative instruction encoding (format) for the SLEEP instruction. As illustrated in FIG. 1b, the format 100 comprises (i) a base instruction element or kernel 102; (ii) one or more operand fields 104; and (iii) one or more flag fields 106. Other configurations are also possible consistent with the invention.

The SLEEP instruction of the present invention may advantageously be put anywhere in the code, for example as shown below:

sub r2, r2, 0x1

add r1, r1, 0x2

sleep

. . .

© 1996-2001 ARC International plc. All rights reserved.

The foregoing example illustrates the use of the SLEEP instruction following subtraction (sub) and addition (add) instructions. In the illustrated example, the SLEEP instruction comprises a single operand instruction without flags or other operands. This instruction is part of the base case instruction set of the core.

As shown in FIG. 1c, one or more additional control bits (sleep mode {ZZ}) are introduced in the debug register 190 of the core of the present embodiment to control lower power modes. The following outlines the general functionality of the sleep mode control bits:

ZZ (Sleep Mode):—Indicates when the core is in sleep mode

0—core is not in sleep mode (default)

1—core is in sleep mode

Read

The Sleep Mode flag (ZZ) is set when the core enters sleep mode as previously described. In the present embodiment of a four-stage pipeline (i.e., fetch, decode, execute, and writeback stages), the ZZ flag is set when a SLEEP instruction arrives in pipeline stage 2, and cleared when the core is restarted or receives an interrupt request of the type previously described.

Setting the core to sleep mode for a limited period of time can be done using the 24-bit timer interrupt unit of the processor. For example, the timer register aux_timer of Assignee's ARC core is incremented by one on every clock cycle. If the least significant bit in the aux_tcontrol register is set, the timer generates an interrupt when the register aux_timer “wraps.” This wrapping occurs one cycle after the aux_timer has reached the maximum value of 0x00FFFFFF. Hence, when the timer wraps, the interrupt signal is generated, and core wakes up from sleep mode as previously described. The following exemplary code illustrates this concept:

.extAuxRegister aux_timer, 0x21, r|w ;
.extAuxRegister aux_tcontrol, 0x22, r|w ;
.section vector
ivec3:jal ivec_handler
_start:
sr 0x1, [aux_tcontrol] ;
flag 2 ;
sr 0x00FF0000, [aux_timer] ;
sleep ;
JAL_start
ivech_handler:
<User defined code>
sr 0x0, [aux_tcontrol] ; Disable interrupt generation

© 1996-2001 ARC International plc. All rights reserved.

In the preceding example, the “sr 0x1” instruction (aux_tcontrol) enables interrupt generation, while “flag 2” enables level 1 interrupts. The “sr 0x00FF0000” instruction sets the start value of the timer to a starting value of 0x00FF0000. When the core encounters the SLEEP instruction, it goes into sleep mode until the timer has counted to 0x00FFFFFF (from the starting value of 0x00FF0000). On the following cycle the timer wraps (i.e. is set to the value 0x00000000) and generates an interrupt signal on (IRQ3) whereby the core wakes up. The interrupt enable flag for level 1 has been set to allow the interrupt signal (IRQ3) to be recognized.

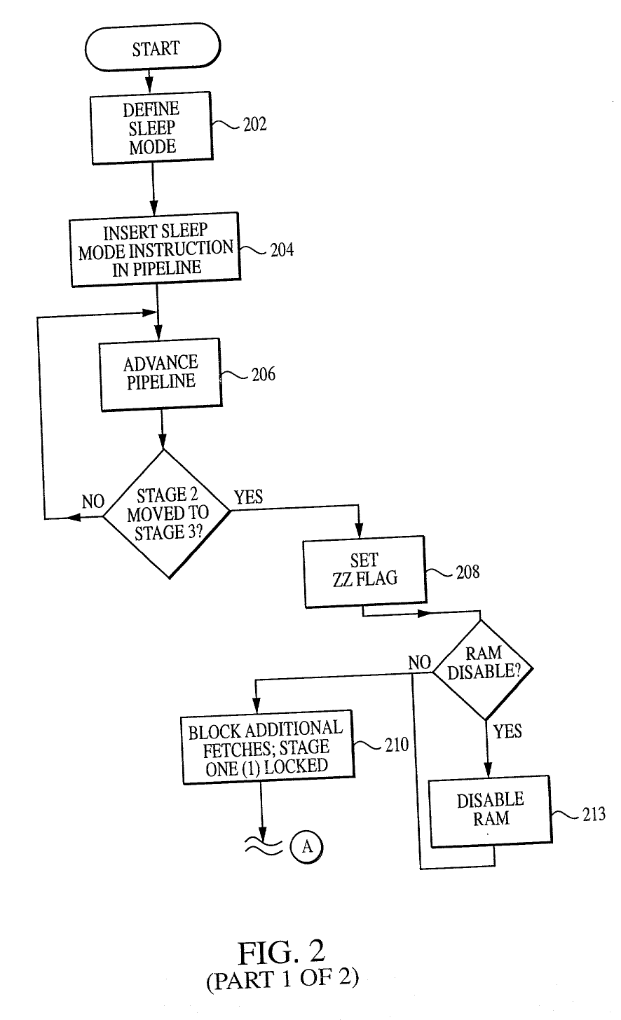

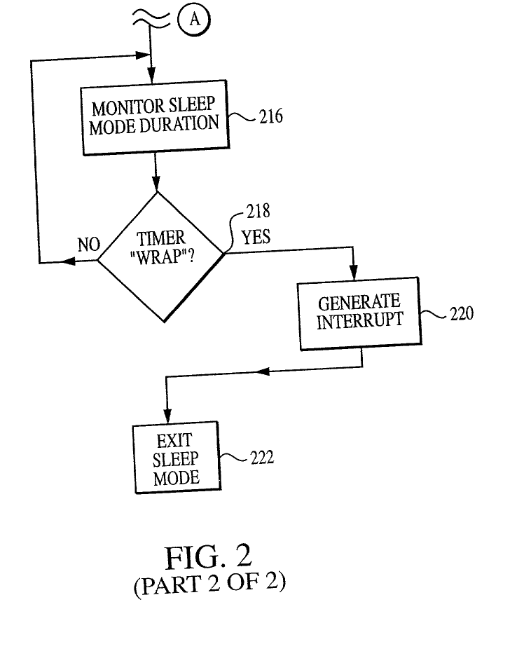

Referring now to FIG. 2, one embodiment of the method of reducing power consumption within a pipelined processor is described. The first step 202 of the method 200 comprises defining a sleep mode for the processor via an instruction word format (such as the foregoing SLEEP word). As part of step 202, the SLEEP instruction is also coded to invoke a pipeline stall and optional disabling of the RAM via the HDL code that defines the pipeline operation. Next in step 204, the SLEEP instruction is inserted into the pipeline at stage 1. In step 206, the pipeline is advanced, with the SLEEP instruction being advanced to stage 2 (decode) of the pipeline. In step 208, the SLEEP instruction at stage 2 sets the ZZ flag when stage 2 is allowed to move into stage 3. When the ZZ flag is set per step 208, the processor enters the sleep mode. No more instruction fetches are allowed and pipeline stage 1 is prevented to move into stage 2 (step 210). Stages 2 and above flow free, however, which means that pipeline stages 2 and above will be flushed in the beginning of the sleep mode (step 212). This means that the SLEEP instruction itself will also be flushed, since the SLEEP instruction in stage 2 is advanced to stage 3 as described above. Also, upon execution, the RAM associated with the processor is optionally disabled per step 213, depending on the HDL coding of the instruction. This disabling of the RAM may be accomplished by many different techniques well know to those of ordinary skill in the art of HDL design, but one exemplary technique is to include a conditional HDL statement that enables/disables the RAM. The sleep mode duration may then be optionally controlled using a timer or similar function, such as the aux_timer function as previously described herein (step 216). In the illustrated embodiment, when the timer function “wraps” per step 218, an interrupt is generated (step 220), and the core wakes from the sleep mode per step 222. It will be recognized, however, that other methods of controlling the duration and entry/exit from sleep mode may be used. For example, the aforementioned interrupt signal may be generated by another function within the core, or may be generated by an external module, such as a disk drive.

Sleep Instruction in Delay Slot

The SLEEP instruction of the present invention may also advantageously be put in a delay slot present in the pipeline, as in the following code example:

```
bal.d after_sleep
    sleep
    . . .
After_sleep:
    add r1,r1,0x2
```

© 1996-2001 ARC International plc. All rights reserved.

As used herein, the term “delay slot” refers to the slot within a pipeline subsequent to a branching or jump instruction being decoded. Branching used consistent with the present invention may be conditional (i.e., based on the truth or value of one or more parameters, such as the value of a flag bit) or unconditional. It may also be absolute (e.g., based on an absolute memory address), or relative (e.g., based on a relative addressing scheme and independent of any particular memory address). In the code example presented above, the processor core enters the sleep mode after the branch instruction has been executed. When the core is in the sleep mode, the program counter (PC) points to the “add” instruction after the label “after_sleep”. When an interrupt occurs, the core wakes up, executes the interrupt service routine, and continues with the add instruction to which the PC is pointing.

Note that if the delay slot is “killed” as in the following code example (i.e., “.nd”), the SLEEP instruction in the delay slot will never be executed:

```
bal.nd after_sleep
    sleep
    . . .
After_sleep:
    add r1,r1,0x2
```

© 1996-2001 ARC International plc. All rights reserved.

It is further noted that the SLEEP instruction of the present invention can be put in the delay slot of a jump instruction to solve the problem with a real-time operating system (RTOS) that sets the interrupt flags in the main memory, the latter required to be cleared before entering the sleep mode. Specifically, the current flag settings are first stored in core register r1. Then, the PC address to which the program jumps after it has been woken up from SLEEP mode is also stored in r1. Consequently the core register r1 will contain both the current flag settings and the exit address towards which the program goes to after the sleep mode. Next, the interrupt enable flags are disabled so that no new interrupt requests can be detected by the processor. All interrupt flags in the memory are serviced until there are no more interrupt flags set. Then the following code is executed:

| | |
|---|---|
| jal.d.f | [r1] |
| sleep | |

The jump instruction will jump to the content of core register 1 [r1]. This register content updates the PC with the exit address of the sleep mode. Also, the flags are reset to the prior setting, thereby potentially enabling the interrupt again. Even if there is an outstanding IRQ at this point, it will not yet be serviced because the jump has a delay slot. The delay slots of the illustrated embodiment are not separable, so the delay slot is executed first. The delay slot contains the sleep mode so consequently the processor goes into sleep mode upon execution. When the processor is in sleep mode, is it once again prepared to receive IRQs. Hence, the IRQs are “blocked out” from that point when the interrupt flags are cleared until sleep mode is entered. This is desirable in order to avoid the condition where an IRQ is being serviced after all interrupt flags have been cleared but before sleep mode is entered. If such condition is allowed to occur, it would be possible for the processor to enter sleep mode with an interrupt flag set in memory. One solution to avoiding this condition is by disposing the SLEEP instruction in a delay slot of a flag setting jump that restores the interrupt enable flags.

The SLEEP instruction of the present invention acts as a no-operation (NOP) instruction during single-step mode since every single-step is treated as a restart and the core wakes up at the next single-step. As used herein, the term “single-step mode” refers generally to modes wherein the processor steps sequentially through a limited number of cycles, a specific example of which being where one processor cycle is initiated per switch closure on the single step pin of the processor. This mode is useful for software debugging and evaluation of pipeline contents during execution.

Note that the sleep mode of the present invention also in some capacity affects the operation of the core's main clock (ck); the clock is switched off only if the core is either halted (en=‘0’) or in sleep_mode (i.e, the aforementioned ZZ-flag is set). This advantageously reduces power consumption associated with clock-driven nets within the core.

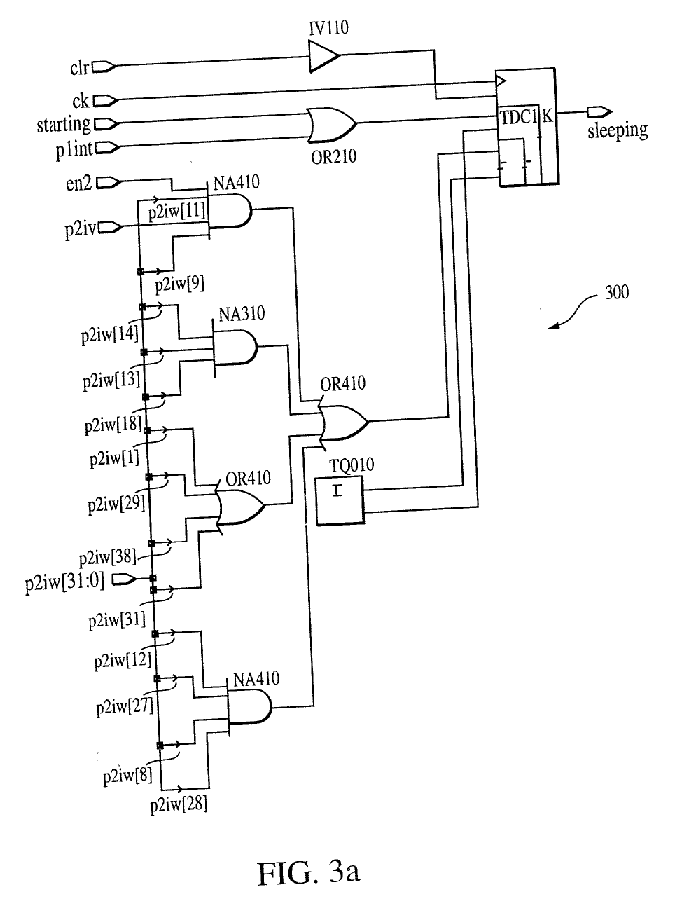

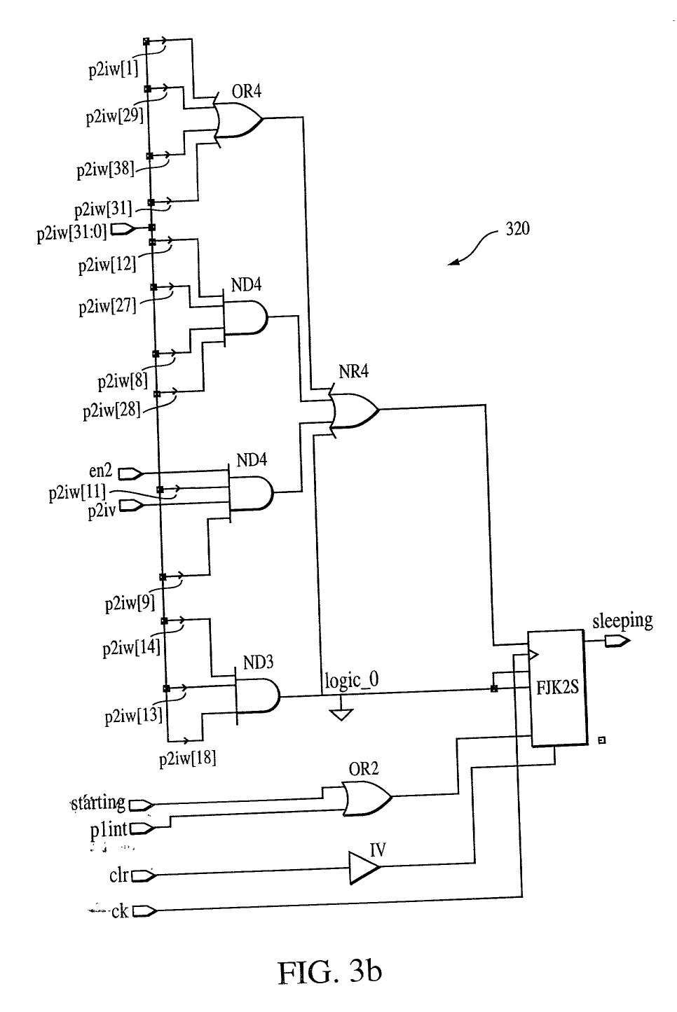

FIGS. 3a and 3b illustrate first and second exemplary embodiments, respectively, of synthesized gate logic 300, 320 used to implement the foregoing sleep mode power reduction functionality within the core.

In addition to the sleep mode, it will be recognized that power consumption within the core can also be reduced through other complementary methods. These other methods are described in detail in the following paragraphs.

Clock Gating

One such method of complementary power reduction comprises clock gating, whereby all clocks within the processor are switched off, except for the clock to the processor interface modules and the timer. Obviously, greater savings in power consumption may be realized if the clock gating option is selected. The sleep mode previously described herein stalls the processor pipeline, but it does not halt the processor otherwise. If the clock gating option has not been selected when the core build was made, then power is saved during sleep mode by the fact that the pipeline remains unchanged and all RAMs are switched off. If clock gating has been selected during core build, then additional power is saved by permitting the clocks in the processor core to be gated. Consequently, the sleep mode of the present invention in effect always saves power, but if clock gating is also selected, the savings are greater. With respect to Assignee's ARC core referenced herein, clock gating is a hardware option that is selected when the core build is created by the hardware engineer (described in greater detail below). Hence, the software programmer has no control over clock gating.

Optionally, when clock gating is utilized, enable debug (ED) control bit(s) may also be specified by the hardware engineer. Enable Debug is a clock gating option for the action points of the core. If this option is selected, then the action point clock is gated when the action points are not used. The following illustrates the ED functionality:

ED (Enable Debug):—Enables the debug extensions

0—Disable the debug extensions (default)

1—Enable the debug extensions

Read

Write only from the host

The enable debug (ED) flag is used to enable the debug clock and thereby turn on the debug extensions. As used herein, the term “debug extensions” refers to optional instructions and other hardware capabilities that are included in the processor to facilitate the debugging process, such as for example extension instructions included as part of the extension instruction set designed to facilitate debug or related processes. ED flag setting is typically accomplished via the host by the debugger just before it needs to access the debug extensions. When the ED flag is clear the debug clock is gated, and the debug extensions are thereby completely switched off. Conversely, when the flag is set, the debug clock is not gated, and the debug extensions are enabled.

Note that the ED flag does not affect the sleep mode in any way; rather, it only controls the clock gating of the debug extensions. The ED flag only works if clock gating was selected by the programmer. If clock gating was not selected during the core build, the ED flag is removed during the synthesis process, the latter being described below.

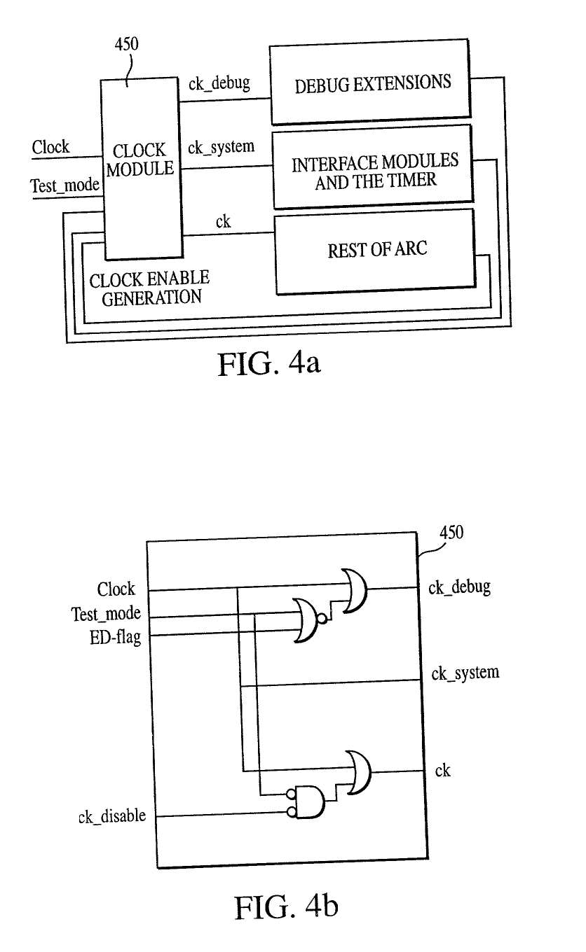

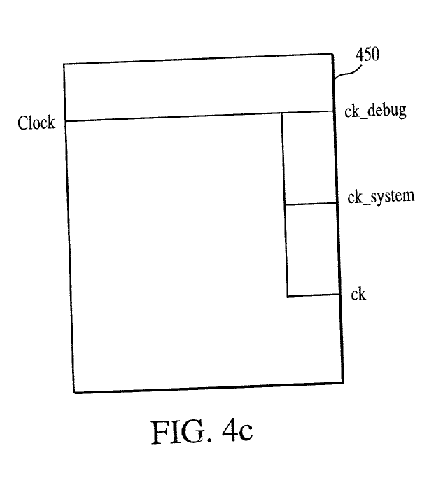

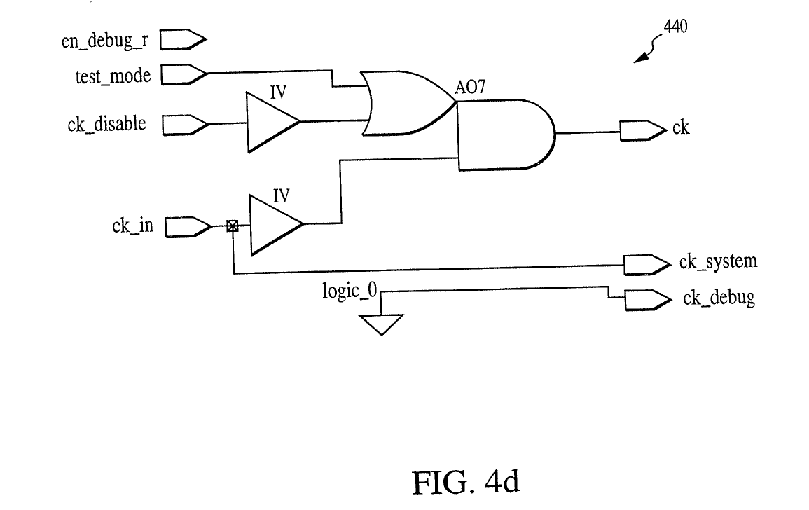

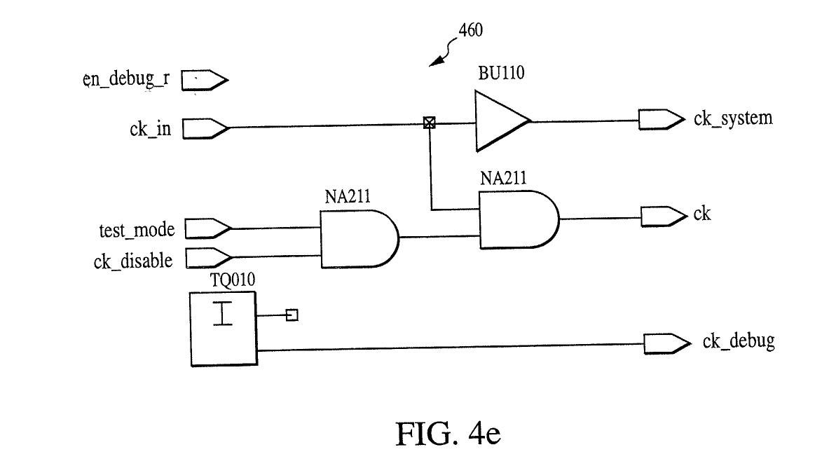

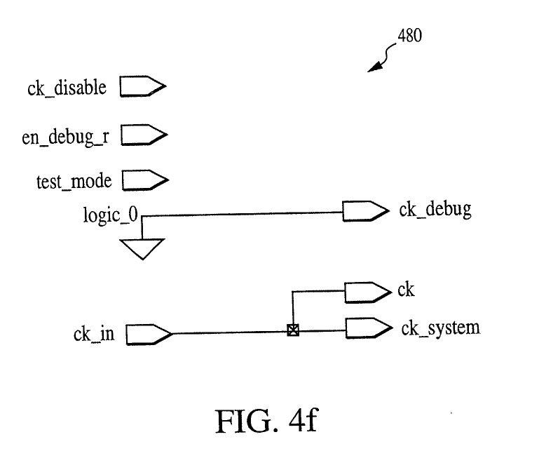

FIG. 4a illustrates the relationship of the core clock module to the rest of the design. The clock module 450 is a part of all core builds, even if clock gating was not selected in the build; however, the content of the clock module varies accordingly. If clock gating was selected, the clock module 450 contains the clock gating (see FIG. 4b). If this option was not selected during core build, the clock module 450 is empty, with all clock outputs directly connected to the input clock (see FIG. 4c). A constant called ck_gating (defined in extutil.vhdl) controls the clock module configuration.

FIGS. 4d-4f illustrate exemplary embodiments of logic 440, 460, 480 used to implement the foregoing clock gating functionality within the processor core. It will be recognized, however, that other logic configurations may be substituted to perform the foregoing functions with equal success, such other configurations being readily determined by those of ordinary skill in the processor design and logic synthesis arts.

Gray Coding

Another such method of complementary power reduction comprises Gray coding the state machines of the core. As is well known in the art, Gray coding comprises forming a binary sequence in which only one bit changes at any given time. By restricting the core design during build such that only one bit changes at the time, power consumption is reduced. Specifically, Gray coding reduces power consumption by reducing the number of nodes that toggle per clock cycle. Since the core's pipeline employs a clock that operates at the highest frequency of the processor, reductions in the number of nodes toggled per clock cycle can be significant. Pipeline control logic is often implemented by state machine logic. Controlling the state transitions to minimize transitions to conform to hazard-free asynchronous state machine design conditions (only one variable changes per clock and the change conforms to a Gray code) minimizes net toggles. It is also possible to design the pipeline control logic for the core such that state transition changes are simply minimized, since the machine is intrinsically synchronous.

Gray code can generally be implemented in two ways within the processor core of the present invention: (i) within the HDL; or (ii) within the synthesis script. Full control over the Gray coding is often best achieved in the HDL. The significant benefit to Gray coding, in contrast to many other power reduction techniques, is that it does not add any extra control logic to the design. Consequently there are very few if any downsides to implementing Gray coding. It should be noted, however, that the power reduced by such coding is normally not as great in magnitude as, for example, disabling a RAM or stalling the pipeline using the sleep mode functionality as previously discussed. As it is basically a rearrangement of existing logic, it generally does not affect timing, layout or design for testability like many other power reduction techniques. Hence, Gray coding may be implemented in conjunction with the sleep mode functionality described above to further reduce core power consumption with effectively no detriments to other aspects of core operation.

One exemplary Gray code for 3 bits is (000, 010, 011, 001, 101, 111, 110, 100). An n-bit Gray code corresponds to a Hamiltonian cycle on an n-dimensional hypercube. While the term Gray code is used herein as if there is only one Gray code, it will be recognized that Gray codes are not unique. One way to construct a Gray code for n bits is to use a Gray code for n−1 bits with each code prefixed by 0 (for the first half of the code) and append the n−1 Gray code reversed with each code prefixed by 1 for the second half.

The following example illustrates the creation of a 3-bit Gray code from a 2-bit Gray code (algorithm derived from “Combinatorial Algorithms,” Reingold, Nievergelt, Deo):

| | |
|---|---|
| 00 01 11 10 | A Gray code for 2 bits |
| 000 001 011 010 | The 2-bit code with a zero prefix |
| 10 11 01 00 | The 2-bit code reversed |
| 110 111 101 100 | The reversed code with a one prefix |
| 000 001 011 010 110 111 101 100 | A Gray code for 3 bits |

The following exemplary code implements this algorithm in the processor:

```
<stdlib.h> void main(void)
{
  int i = 0, j, n, *g, *t;
  printf( “Enter n: ”);
  scanf( “%d”, &n );
  g = malloc( (n+2) * sizeof(int));
  t = malloc( (n+2) * sizeof(int));
  for (j=0; j <= n+1; j++)
  {
  g[j] = 0;
  t[j] = j+1;
  }
  while (i < n+1)
  {
  for (j=n; j; j−−) printf( “%2dt”, g[j]);
  printf(“\n”);
  i = t[0];
  g[i] = !g[i];
  t[0] = 1;
  t[i−1] = t[i];
  t[i] = i+1;
  }
}
© 1996-2001 ARC International plc. All rights reserved.
```

The following model implements a Gray code counter with adjustable counter width (SIZE). It will be appreciated that there are many alternative ways of expressing the same algorithm, alternative algorithms to accomplish the same function, and other representation techniques which product equivalent results. This description is intended to be illustrative and merely exemplary of the present invention.

entity gray_counter is:

```
generic (SIZE : Positive range 2 to Integer′High);
port (clk: in bit;
  gray_code : inout bit_vector(SIZE-1 down to 0));
end gray_counter;
architecture behave of gray_counter is
begin
gray_incr: process (clk)
  variable tog: bit_vector(SIZE-1 down to 0);
begin
if clk′event and clk = ‘1’ then
tog := gray_code;
for i in 0 to SIZE-1 loop
tog(i) := ‘0’;
for j in i to SIZE-1 loop
tog(i) := tog(i) XOR gray_code(j);
end loop;
tog(i) := NOT tog(i);
for j in 0 to i−1 loop
tog(i) := tog(i) AND NOT tog(j);
end loop;
end loop;
tog(SIZE-1) := ‘1’;
for j in 0 to SIZE-2 loop
tog(SIZE-1) := tog(SIZE-1) AND NOT tog(j);
end loop;
gray_code <= gray_code XOR tog;
end if;
end process gray_incr;
  end behave;
  © 1996-2001 ARC International plc. All rights reserved.
```

Pipeline Logic Modification

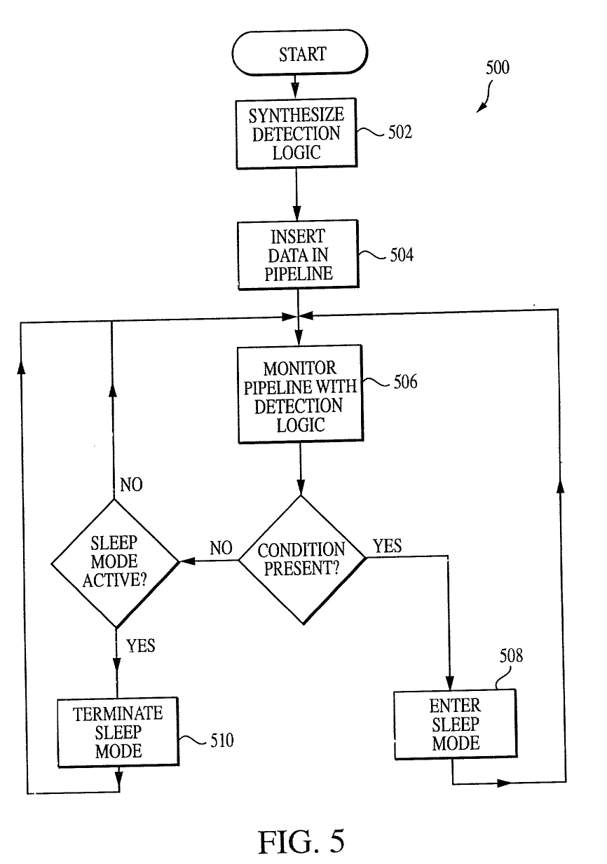

Yet another such method of power consumption reduction involves modification of the processor pipeline logic. Such logic is ubiquitous in pipelined processor core designs to control the function and operation of the pipeline during varying conditions. In the exemplary embodiment of FIG. 5, the method 500 of reducing power consumption comprises first providing a logic circuit adapted for detection of a predetermined condition of the data within the pipeline (step 502); inserting data into the pipeline (step 504); detecting, using the logic circuit, that the predetermined condition exists with respect to certain of the data (step 506); invoking a sleep mode within the pipeline in response to the detected condition (508); and restarting the pipeline when the condition no longer exists (step 510). For example, under some circumstances, it may be determined by the processor that data that is present in the pipeline will not be used at a later stage. Such conditions include anticipatory execution of an instruction which is then subsequently stopped by a conditional evaluation.

Specifically, the pipeline logic may be modified to prevent unnecessary switching activity in two ways: (i) by generating a “low power” version of the pipeline enable signal en1 (e.g., en1_lowpower); and (ii) by generating the enable signal en2 (which controls the data path to the ALU of the core) differently. In the case of both the generation of en1_lowpower and en2, the modification comprises activating the two enable signals (individually) if the pipeline stage contains valid data. Accordingly, data determined to be no longer valid, or of no further use, is not propagated down the pipeline, thereby conserving power. As enable signal en2 controls the data path to the arithmetic logic unit (ALU) with respect to all extensions, this second modification results in a progressively larger and larger power reduction as more extensions are used. This is particularly useful in extended processor architectures such as that of Assignee's ARC core, which routinely utilize a plurality of extension instructions within the processor's instruction set.

Core Extensions

With respect to the core arithmetic logic unit (ALU), if one extension is used, all extensions are activated. If no extensions are used, none is activated as the data path is forced to zero. This simple condition provides significant power reduction and is generally independent of a core configuration and chosen technology.

For some extensions, the foregoing process may add a delay to the critical path and thereby reduce the maximum clock frequency. If this is not acceptable, it is a simple matter to use the non-low power version. If a timing problem exists with one of the extensions, the normal data path (s1val and s2val) is selected. It is acceptable to change only the extension that is on the critical path, while letting all the other extensions use the low power version of the data path. Hence, the only reason not to use the low power version is if the extension in question will be on the critical path, and add too much delay, thereby adversely impacting the target clock frequency of the resulting design.

The small multi-cycle extensions of the ARC core (e.g., small mulmac and small multiplier) can be further reduced in power consumption by using Gray code of the type previously described herein. Of the two methods of introducing Gray code previously discussed (i.e., in synthesis script or in HDL code), only the HDL solution gives a robust result, even though it provides only a few percent overall power reduction. Further reduction in the overall power consumption can be achieved by modifying the extension ALU of the core.

Furthermore, the very fact that the exemplary ARC core described herein is configurable is highly advantageous from a power point of view. By only choosing those modules that will actually be used by the design, much unnecessary power consumption can be removed. This is a major advantage of configurable cores (such as the ARC) over non-configurable cores. Another important feature of such cores is the ability to design extensions to minimize cycle counts for common or recurring functions, thereby reducing the power consumption. Hence, by (i) choosing only modules used by the design; (ii) designing extensions adapted to minimize cycle counts; and (iii) utilization of one or more of the foregoing power reduction functions (e.g., sleep mode, clock gating, pipeline logic modification), the overall power consumption of the core can be significantly reduced.

While it is seemingly intuitive to only choose those modules that will actually be used in the design, there some choices that are less obvious. The following factors may also be germane to achieving minimal power consumption under typical circumstances: (i) use of D-latches as register file; (ii) use of fast barrel instead of small barrel; (iii) use of fast multiplier instead of small multiplier; and (iv) use of small mulmac instead of fast mulmac.

It should also be recognized that the slower extensions do not always consume less power than the faster versions. One of the reasons for this behavior is that certain power saving measures (e.g., Gray coding) may be more successful on the fast single-cycle extensions than the small multi-cycle extensions.

Method of Synthesizing

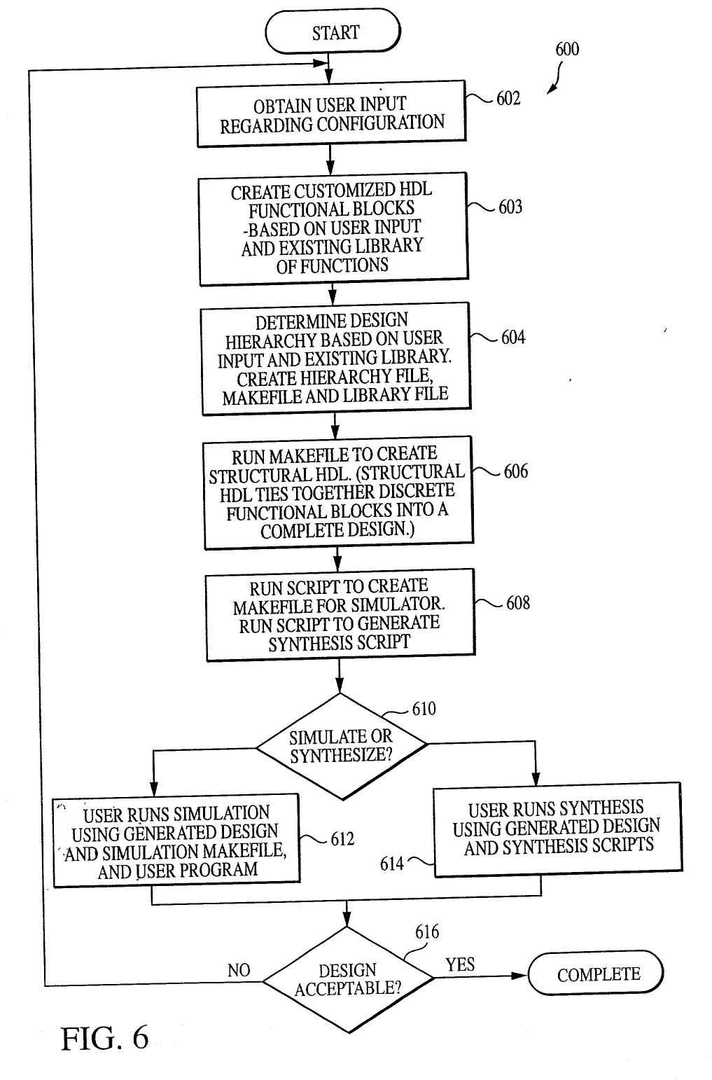

Referring now to FIG. 6, the method 600 of synthesizing logic incorporating the sleep mode, clock gating, Gray coding, and pipeline enable (en1, en2) functionality previously discussed is described. The generalized method of synthesizing integrated circuit logic having a user-customized (i.e., “soft”) instruction set is disclosed in Applicant's co-pending U.S. patent application Ser. No. 09/418,663 entitled “Method And Apparatus For Managing The Configuration and Functionality of a Semiconductor Design” filed Oct. 14, 1999, which claims the priority benefit of U.S. provisional application Serial No. 60/104,271 of the same title filed Oct. 14, 1998, both of which are incorporated herein by reference in their entirety.

While the following description is presented in terms of an algorithm or computer program running on a microcomputer or other similar processing device, it can be appreciated that other hardware environments (including minicomputers, workstations, networked computers, “supercomputers”, and mainframes) may be used to practice the method. Additionally, one or more portions of the computer program may be embodied in hardware or firmware as opposed to software if desired, such alternate embodiments being well within the skill of the computer artisan.

Initially, user input is obtained regarding the design configuration in the first step 602. Specifically, desired modules or functions for the design are selected by the user, and instructions relating to the design are added, subtracted, or generated as necessary. For example, in signal processing applications, it is often advantageous for CPUs to include a single “multiply and accumulate” (MAC) instruction. In the present invention, the instruction set of the synthesized design is modified so as to incorporate the foregoing SLEEP instruction and associated logic (and/or other power reduction functionality) therein.

The technology library location for each VHDL file is also defined by the user in step 602. The technology library files in the present invention store all of the information related to cells necessary for the synthesis process, including for example logical function, input/output timing, and any associated constraints. In the present invention, each user can define his/her own library name and location(s), thereby adding further flexibility.

Next, in step 603, the user creates customized HDL functional blocks based on the user's input and the existing library of functions specified in step 602.

In step 604, the design hierarchy is determined based on user input and the aforementioned library files. A hierarchy file, new library file, and makefile are subsequently generated based on the design hierarchy. The term “makefile” as used herein refers to the commonly used UNIX makefile function or similar function of a computer system well known to those of skill in the computer programming arts. The makefile function causes other programs or algorithms resident in the computer system to be executed in the specified order. In addition, it further specifies the names or locations of data files and other information necessary to the successful operation of the specified programs. It is noted, however, that the invention disclosed herein may utilize file structures other than the “makefile” type to produce the desired functionality.

In one embodiment of the makefile generation process of the present invention, the user is interactively asked via display prompts to input information relating to the desired design such as the type of “build” (e.g., overall device or system configuration), width of the external memory system data bus, different types of extensions, cache type/size, use of clock gating, Gray coding restrictions, etc. Many other configurations and sources of input information may be used, however, consistent with the invention.

In step 606, the user runs the makefile generated in step 604 to create the structural HDL. This structural HDL ties the discrete functional block in the design together so as to make a complete design.

Next, in step 608, the script generated in step 606 is run to create a makefile for the simulator. The user also runs the script to generate a synthesis script in step 508.

At this point in the program, a decision is made whether to synthesize or simulate the design (step 610). If simulation is chosen, the user runs the simulation using the generated design and simulation makefile (and user program) in step 612. Alternatively, if synthesis is chosen, the user runs the synthesis using the synthesis script(s) and generated design in step 614. After completion of the synthesis/simulation scripts, the adequacy of the design is evaluated in step 616. For example, a synthesis engine may create a specific physical layout of the design that meets the performance criteria of the overall design process yet does not meet the die size requirements. In this case, the designer will make changes to the control files, libraries, or other elements that can affect the die size. The resulting set of design information is then used to re-run the synthesis script.

If the generated design is acceptable, the design process is completed. If the design is not acceptable, the process steps beginning with step 602 are re-performed until an acceptable design is achieved. In this fashion, the method 600 is iterative.

Furthermore, it will be recognized that different technology libraries have different relations between net switching power and cell internal power and also different relations between different technology cells. This is a concern for designers who will have their design implemented in different technologies. Even if some change of the HDL leads to power reduction in one technology library, it might lead to an increase in power consumption in another library. Thus, under such circumstances, it is important to test changes on the several different technologies which are implicated to verify that the power reductions are robust.

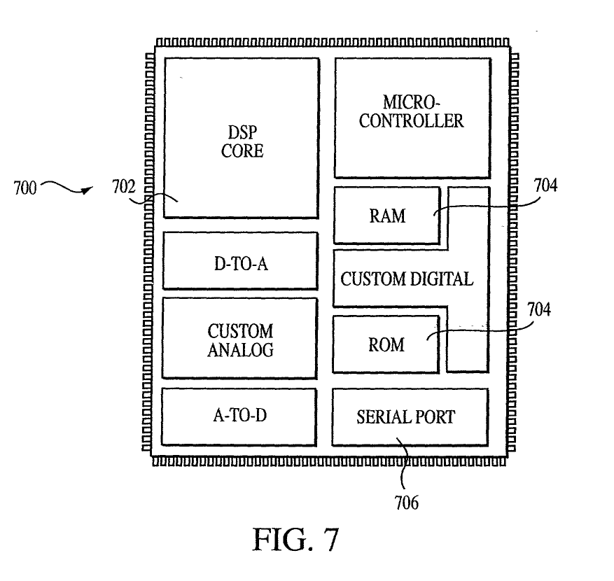

FIG. 7 illustrates an exemplary pipelined processor fabricated using a 1.0 um process. As shown in FIG. 7, the processor 700 is an ARC microprocessor-like CPU device having, inter alia, a processor core 702, on-chip memory 704, and an external interface 706. The device is fabricated using the customized VHDL design obtained using the method 600 of the present invention, which is subsequently synthesized into a logic level representation, and then reduced to a physical device using compilation, layout and fabrication techniques well known in the semiconductor arts.

It will be appreciated by one skilled in the art that the processor of FIG. 6 may contain any commonly available peripheral such as serial communications devices, parallel ports, timers, counters, high current drivers, analog to digital (A/D) converters, digital to analog converters (D/A), interrupt processors, LCD drivers, memories and other similar devices. Further, the processor may also include custom or application specific circuitry. The present invention is not limited to the type, number or complexity of peripherals and other circuitry that may be combined using the method and apparatus. Rather, any limitations are imposed by the physical capacity of the extant semiconductor processes which improve over time. Therefore it is anticipated that the complexity and degree of integration possible employing the present invention will further increase as semiconductor processes improve.

It is also noted that many IC designs currently use a microprocessor core and a DSP core. The DSP however, might only be required for a limited number of DSP functions, or for the IC's fast DMA architecture. The invention disclosed herein can support many DSP instruction functions, and its fast local RAM system gives immediate access to data. Appreciable cost savings may be realized by using the methods disclosed herein for both the CPU & DSP functions of the IC.

Additionally, it will be noted that the methodology (and associated computer program) as previously described herein can readily be adapted to newer manufacturing technologies, such as 0.18 or 0.1 micron processes, with a comparatively simple re-synthesis instead of the lengthy and expensive process typically required to adapt such technologies using “hard” macro prior art systems.

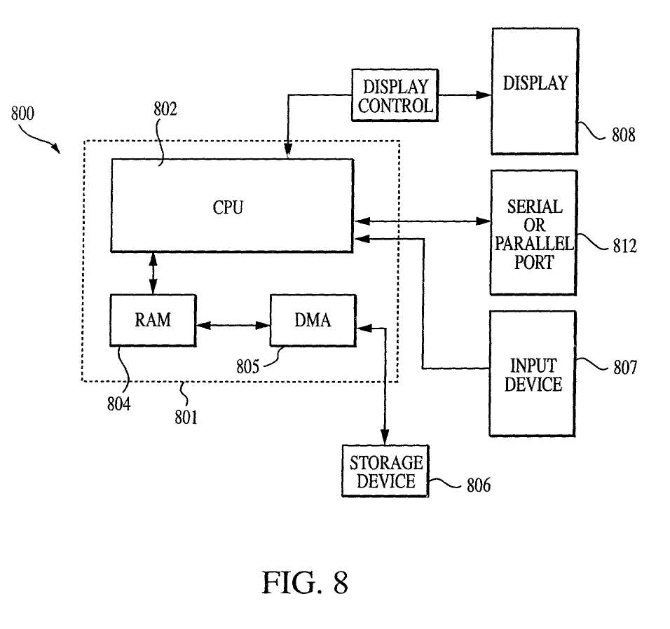

Referring now to FIG. 8, one embodiment of a computing device capable of synthesizing logic structures capable of implementing the delayed breakpoint decode and pipeline performance enhancement methods discussed previously herein is described. The computing device 800 comprises a motherboard 801 having a central processing unit (CPU) 802, random access memory (RAM) 804, and memory controller 805. A storage device 806 (such as a hard disk drive or CD-ROM), input device 807 (such as a keyboard or mouse), and display device 808 (such as a CRT, plasma, or TFT display), as well as buses necessary to support the operation of the host and peripheral components, are also provided. The aforementioned VHDL descriptions and synthesis engine are stored in the form of an object code representation of a computer program in the RAM 804 and/or storage device 806 for use by the CPU 802 during design synthesis, the latter being well known in the computing arts. The user (not shown) synthesizes logic designs by inputting design configuration specifications into the synthesis program via the program displays and the input device 807 during system operation. Synthesized designs generated by the program are stored in the storage device 806 for later retrieval, displayed on the graphic display device 808, or output to an external device such as a printer, data storage unit, other peripheral component via a serial or parallel port 812 if desired.

It will be recognized that while certain aspects of the invention have been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

APPENDIX I
HDL DESCRIPTION
© 1996-2001 ARC International plc. All rights reserved.

-- Sleep mode:
--
-- When the sleep mode flag ZZ (i_sleeping) in the debug
-- register is set the ARC enters sleep mode. This happens when
-- a sleep instruction is detected in pipeline stage 2
-- (p2sleep_inst = ‘1’). The ARC stays in sleep mode until, e.g., an inter-
-- rupt is requested (p1int = ‘1’) or the ARC is restarted (starting = ‘1’).

sleep_mode_proc: PROCESS(clr, ck)
BEGIN

IF clr = ‘1’ THEN

i_sleeping <= ‘0’;

ELSIF (ck′EVENT AND ck = ‘1’) THEN

IF (p1int = ‘1’ OR starting = ‘1’) THEN

i_sleeping <= ‘0’;

ELSIF (p2sleep_inst = ‘1’ AND en2 = ‘1’) THEN

i_sleeping <= ‘1’;

END IF;

END IF;

END PROCESS sleep_mode_proc;
sleeping <= i_sleeping;

END synthesis;
----------------------- Sleep Mode signals ---------------------------------
-
-- out AP_p3disable_r L To flags.vhdl. This signals to the ARC that the

| | |
|---|---|
| -- | pipeline has been flushed due to a breakpoint or sleep |
| - | instruction. If it was due to a breakpoint instruction |
| -- | the ARC is halted via the ‘en’ bit, and the AH bit is |
| | set to ‘1’ in the debug register. |
| -- in sleeping | This is the sleep mode flag ZZ in the debug register |
| -- | (bit 23). When it is true the ARC is stalled. This flag |
| -- | is set in debug.vhdl when the p2sleep_inst is true and |
| -- | cleared on restart or interrupt. |
| -- | |

-- out p2sleep_inst This signal is set when a sleep instruction has been

| | |
|---|---|
| -- | decoded in pipeline stage 2. It is used to set the sleep |
| -- | mode flag ZZ (bit 23) in the debug register. |
| -- | |

--------------------------------** Stage 2 **------------------------------
--
-- The sleep instruction is determined at stage 2 from:
--
-- [1] Decode of p2iw,
-- [2] Instruction at stage 2 is valid.
--
--

| | | | |
|---|---|---|---|
| ip2sleep_inst <= | ‘1’ | WHEN | (ip2iw(instrubnd downto instrlbnd) = |
| oflag) | | | |
| | | AND | (ip2iw(copubnd downto coplbnd) = |
| so_sleep) | | | |
| | | AND | (ip2iw(shimmlbnd) = ‘1’) |
| | | AND | (ip2iv = ‘1’) ELSE |

‘0’;

p2sleep_inst <= ip2sleep_inst;

| | | |
|---|---|---|
| I_break_stage1 | <= “1” WHEN | I_break_inst = ‘1’ |
| | | OR Ip2sleep_inst = ‘1’ |
| | | OR sleeping = ‘1’ |
| | | Or (actionhalt = ‘1’ |
| | | AND I_kill_AP = ‘0’) ELSE |

‘)’;

END synthesis;

We claim:

1. A method of operating a pipelined digital processor having a memory, comprising:
defining a first instruction, said first instruction being adapted to stall the pipeline of said processor upon execution thereof;
providing said first instruction within said pipeline;
decoding said first instruction;
executing said first instruction;
stalling said pipeline in response to said first instruction;
disabling said memory in response to said first instruction; and
restarting said pipeline and enabling said memory upon the occurrence of a predetermined event.

2. The method of claim 1, wherein said predetermined event comprises a program interrupt.

3. The method of claim 2, wherein said program interrupt comprises transfer of programmatic control to an interrupt service routine.

4. The method of claim 1, wherein said predetermined event comprises a restart condition, said processor being re-enabled after having been halted.

5. The method of claim 1, further comprising waiting for a wait state duration time after said act of disabling but before said pipeline is restarted.

6. The method of claim 2, further comprising preventing the setting of interrupt flags from that point when the interrupt flags are cleared until said pipeline is stalled.

7. The method of claim 1, wherein said act of providing said first instruction within said pipeline comprises:
providing a flag setting branch instruction having a delay slot within said pipeline;
disposing said first instruction in said delay slot of said flag setting branch instruction.

8. The method of claim 1, further comprising:
providing a logic circuit adapted for detection of a predetermined condition of the data within the pipeline;
inserting data into the pipeline;
detecting, using said logic circuit, that the predetermined condition exists with respect to certain of the data;
invoking a sleep mode within the pipeline in response to said detected condition if no such sleep mode is already invoked; and
permissively restarting the pipeline when the condition no longer exists.

9. The method of claim 8, wherein said act of permissively restarting said pipeline comprises restarting said pipeline only if restart has been or is concurrently enabled by the occurrence of said predetermined event.

10. The method of claim 8, wherein said act of detecting said predetermined condition of said data comprises using said logic circuit to detect when said data will not be used in a later stage of said pipeline.

11. The method of claim 10, wherein said act of detecting when said data will not be used comprises detecting the activation of first and second enable signals, said first and second enable signals being activated if the current pipeline stage contains valid data.

12. The method of claim 11, further comprising:
providing a plurality of extension instructions within the instruction set architecture of said processor;
wherein said act of activating said second enable signal comprises enabling the data path to the arithmetic logic unit (ALU) with respect to all of said plurality of extension instructions.

13. The method of claim 8, wherein said act of detecting said predetermined condition comprises detecting the anticipatory execution of an instruction within said pipeline, said instruction being subsequently stopped by a conditional evaluation conducted by said processor.

14. The method of claim 10, wherein said act of detecting said predetermined condition comprises detecting the anticipatory execution of an instruction within said pipeline, said instruction being subsequently stopped by a conditional evaluation.

15. The method of claim 1, further comprising switching off a plurality of clocks within said processor in response to said act of stalling.

16. The method of claim 15, further comprising preserving the clocks serving the interface module and timer of said processor in an active state.

17. The method of claim 1, further comprising changing the status of at least one debug flag, said act of changing status thereby disabling at least one debug clock associated with said processor.

18. The method of claim 1, further comprising limiting the number of nodes within at least a portion of the gate logic of said processor that toggle per clock cycle.

19. The method of claim 18, further comprising limiting the number of bits in a binary sequence present within said data that change per clock cycle to a predetermined number.

20. The method of claim 15, further comprising limiting the number of nodes within at least a portion of the gate logic of said processor that toggle per clock cycle.

21. A method of operating a pipelined digital processor having a logic circuit adapted for detection of a predetermined condition with respect to at least a portion of the data within said pipeline, comprising:
inserting a plurality of data into said pipeline;
detecting, using said logic circuit, that the predetermined condition exists with respect to certain of said data;
stalling said pipeline in response to said detected condition if no such pipeline stall is already invoked;
checking for the presence of said condition at least once thereafter; and
restarting the pipeline when said detected condition no longer exists.

22. The method of claim 21, wherein said act of restarting said pipeline comprises permissively restarting said pipeline only if restart has been or is concurrently enabled by the occurrence of a predetermined event.

23. The method of claim 22, wherein said predetermined event comprises a program interrupt request (IRQ).

24. The method of claim 21, wherein said act of detecting said predetermined condition of said data comprises using said logic circuit to detect when said data will not be used in a later stage of said pipeline.

25. The method of claim 24, wherein said act of detecting when said data will not be used comprises detecting the activation of first and second enable signals, said first and second enable signals being activated if the current pipeline stage contains valid data.

26. The method of claim 25, wherein said act of activating said second enable signal comprises enabling the data path to the arithmetic logic unit (ALU) with respect to all extension instructions of said processor.

27. The method of claim 21, wherein said act of detecting said predetermined condition comprises detecting the anticipatory execution of an instruction within said pipeline, said instruction being subsequently stopped by a conditional evaluation conducted by said processor.

28. A digital processor, comprising:
a pipeline having at least fetch, decode, and execute stages, said pipeline adapted to process a plurality of instructions and data therein, said pipeline further being adapted to allow for stalling thereof, said plurality of instructions comprising at least one extension instruction;
an arithmetic logic unit (ALU) operatively coupled to said pipeline, said ALU processing at least a portion of said data based at least in part on said at least one extension instruction; and
logic operatively coupled to said pipeline and adapted to:
(i) detect the validity of at least a portion of said data present in a first stage of said pipeline;
(ii) initiate a stall condition in said pipeline;
(iii) re-evaluate the validity of said data at least once after said stall condition is initiated; and
(iv) remove said stall condition when said at least portion of said data is valid.

29. The processor of claim 28, further comprising first and second enable signal logic, said first and second enable signal logic generating respective first and second enable signals when said first pipeline stage contains valid data.

30. The method of claim 29, wherein said second enable signal enables at least a portion of the data path to said ALU.

31. The processor of claim 28, wherein said logic is further adapted to detect the anticipatory execution of a first instruction within said pipeline, said first instruction being subsequently stopped by a conditional evaluation conducted by said processor.

32. The processor of claim 28, further comprising a plurality of clocks, wherein said processor is further adapted to switch off at least a portion of said plurality of clocks in response to said stall condition.

33. The processor of claim 32, wherein said plurality of clocks excludes the clocks serving the interface module and timer of said processor.

34. The processor of claim 28, further comprising:
at least one debug clock;
at least one debug flag; and
logic adapted to change the status of said at least one debug flag, said status change disabling said at least one debug clock.

35. The processor of claim 28, wherein said logic is further configured to limit the number of bits present in a binary sequence that change per clock cycle to a predetermined number

36. A digital processor, comprising:
a processor core having a pipeline with at least fetch, decode, and execute stages, said pipeline adapted to process a plurality of instructions and data therein, including at least one first instruction adapted to stall said pipeline;
an arithmetic logic unit (ALU) operatively coupled to said pipeline, said ALU being adapted to process at least a portion of said data based on said instructions;
first logic operatively coupled to said pipeline and adapted to detect the presence of said at least one first instruction within said pipeline and stall said pipeline upon execution thereof;
second logic operatively coupled to said pipeline and adapted to restart said pipeline after stalling upon the occurrence of a predetermined event.

37. The digital processor of claim 36, further comprising:
a data storage device operatively coupled to said processor core; and
third logic operatively coupled to said first logic and said data storage device, said third logic being configured to disable said data storage device upon the stalling of said pipeline by said first logic.

38. The digital processor of claim 37, further comprising fourth logic adapted to re-enable said data storage device upon restart of said pipeline by said second logic.

39. The digital processor of claim 36, further comprising logic adapted to:
(i) detect the validity of at least a portion of said data present in said pipeline;
(ii) initiate a stall condition in said pipeline if said at least portion is not valid;
(iii) re-evaluate the validity of said data at least once after said stall condition is initiated; and
(iv) remove said stall condition when said at least portion of said data is valid.

40. The digital processor of claim 39, further comprising first and second enable signal logic, said first and second enable signal logic generating respective first and second enable signals when said pipeline contains valid data.

41. The digital processor of claim 40, wherein said second enable signal enables at least a portion of the data path to said ALU.

42. The digital processor of claim 36, further comprising a plurality of clocks, wherein said processor is further adapted to switch off at least a portion of said plurality of clocks in response to said pipeline stall.

43. The digital processor of claim 42, further comprising an interface module and timer, and wherein said plurality of clocks excludes the clocks serving said interface module and timer.

44. The digital processor of claim 36, further comprising:
at least one debug clock;
at least one debug flag; and
flag setting logic adapted to change the status of said at least one debug flag, said status change disabling said at least one debug clock.

45. The digital processor of claim 36, wherein at least a portion of said first or second logic is configured to limit the number of bits present in a binary sequence of said data that change per clock cycle to a predetermined number.

46. The digital processor of claim 36, wherein said at least first instruction is disposed within a delay slot of a flag setting branch instruction.

47. The digital processor of claim 46, wherein said branch instruction comprises a jump instruction, said jump being conditional on at least one condition within said pipeline.

48. The digital processor of claim 39, wherein said plurality of instructions comprises at least one extension instruction, and said processor further comprises an extension ALU.

49. A method of operating a digital processor core having a multi-stage pipeline, a program counter (PC), a plurality of core registers, a storage device adapted to store a plurality of data therein, and a plurality of flags, including interrupt flags stored in said storage device, said processor core including an instruction set having at least one branch instruction and an associated delay slot, and at least one first instruction disposed in said delay slot and adapted to stall said pipeline upon execution, comprising:
storing the settings associated with said interrupt flags in a first of said core registers;
storing a destination address in said first core register;
temporarily blocking new interrupt requests;
processing all said interrupt flags stored in said storage device;
executing said branch instruction to branch to said first core register;
updating said PC with said destination address;
unblocking said interrupt requests; and
executing said first instruction to cause said pipeline to stall with no interrupt flags set in said storage device.

50. The method of claim 49, wherein said act of blocking new interrupt requests comprises setting at least one interrupt enable flag.

51. The method of claim 49, wherein said first instruction comprises a SLEEP instruction.

52. The method of claim 49, wherein said at least one first instruction comprises a jump instruction.

53. The method of claim 49, further comprising disabling at least a portion of said storage device in response to said execution of said first instruction.

54. The method of claim 53, further comprising disabling at least one clock within said processor in response to said execution of said first instruction.

55. A digital processor, comprising:
a processor core having:
a multi-stage pipeline;
a program counter (PC);
a plurality of core registers;
a plurality of flags, including interrupt flags;
an instruction set having:
(i) at least one branch instruction and an associated delay slot; and
(ii) at least one first instruction disposed in said delay slot, said first instruction adapted to stall said pipeline upon execution: and
a storage device adapted to store a plurality of data therein, including said interrupt flags;
wherein said processor is adapted to stall said pipeline using the method comprising:
storing the settings associated with said interrupt flags in a first of said core registers;
storing a destination address in said first core register;
temporarily blocking new interrupt requests;
processing all said interrupt flags stored in said storage device;
executing said branch instruction to branch to said first core register;
updating said PC with said destination address;
unblocking said interrupt requests; and
executing said first instruction to cause said pipeline to stall with no interrupt flags set in said storage device.

56. The processor of claim 55, further comprising logic operatively coupled to said pipeline and adapted to:
(i) detect the validity of at least a portion of data present in a first stage of said pipeline;
(ii) initiate a stall condition in said pipeline;
(iii) re-evaluate the validity of the data in said pipeline at least once after said stall condition is initiated; and
(iv) remove said stall condition when said at least portion of the data in said pipeline is valid.

57. The processor of claim 55, further comprising:
at least one debug clock;
at least one debug flag; and
logic adapted to change the status of said at least one debug flag in response to said execution of said first instruction, said status change disabling said at least one debug clock.

58. The processor of claim 55, further comprising apparatus adapted to disable at least a portion of said storage device in response to said execution of said first instruction.

59. A digital processor optimized for reduced power consumption, comprising:
a processor core having a multi-stage pipeline;
a storage device capable of storing a plurality of data therein;
a plurality of clock signal generators;
an instruction set having at least one first instruction, said first instruction being adapted to stall said pipeline upon execution thereof;
first logic adapted to disable at least a portion of said storage device in response to stalling of said pipeline by said at least one first instruction;
second logic adapted to secure at least a portion of said plurality of clock signal generators in response to said stalling of said pipeline.

60. The digital processor of claim 59, further comprising third logic operatively coupled to said pipeline and adapted to:
(i) detect the validity of at least a portion of the data present in a first stage of said pipeline;
(ii) initiate a stall condition in said pipeline;
(iii) re-evaluate the validity of the data at least once after said stall condition is initiated; and
(iv) remove said stall condition when said at least portion of the data in said pipeline is valid.

61. The digital processor of claim 59, wherein said instruction set comprises a branch instruction having a delay slot, said first instruction being disposed in said delay slot.

62. The digital processor of claim 59, further comprising a timer, wherein said timer is adapted to generate an interrupt request upon the occurrence of a predetermined event, said interrupt request restarting said pipeline after stalling by said first instruction.

63. The digital processor of claim 62, wherein said predetermined event comprises wrapping of the timer at its maximum value.

64. A method of operating a pipelined data processor having a program counter (PC), core registers, interrupt, and storage device, said processor further being configured with a sleep mode invoked using a sleep instruction, the method comprising:
storing at least one current flag setting in a first core register;
storing a destination address in said first core register;
disabling the interrupt enable in said core;
servicing any interrupt flags present in said storage device;
executing a jump instruction to said first register;
updating said PC with said destination address present in said first register;
enabling said interrupt enable in said core; and
executing said sleep instruction to cause said processor to enter said sleep mode with said interrupt flags in said storage device cleared.

65. The processor of claim 28, wherein said logic is further configured to limit the number of bits present in a binary sequence that change per clock cycle to a minimum number.

66. A digital processor, comprising:
a pipeline having at least fetch, decode, and execute stages, said pipeline adapted to process a plurality of instructions and data therein, said pipeline further being adapted to allow for stalling thereof, said plurality of instruction means comprising at least one extension instruction means;
means for performing arithmetic operations, said means being operatively coupled to said pipeline and processing at least a portion of said data based at least in part on said at least one extension instruction means; and
logic means operatively coupled to said pipeline and adapted to:
(i) detect the validity of at least a portion of said data present in a first stage of said pipeline;
(ii) initiate a stall condition in said pipeline;
(iii) re-evaluate the validity of said data at least once after said stall condition is initiated; and
(iv) remove said stall condition when said at least portion of said data is valid.

67. The processor of claim 66, further comprising:
at least one debug clock means;
at least one means for flagging; and
logic means adapted to change the status of said at least one means for flagging, said status change disabling said at least one debug clock means.

68. A digital processor, comprising:
processor core means having a pipeline with at least fetch, decode, and execute stages, said pipeline adapted to process a plurality of instructions and data therein, including at least one first instruction adapted to stall said pipeline;
arithmetic logic means operatively coupled to said pipeline, said logic means being adapted to process at least a portion of said data based on said instructions;
means for detecting the presence of said at least one first instruction within said pipeline and stall said pipeline upon execution thereof;
means for restarting said pipeline after stalling upon the occurrence of a predetermined event.

69. A digital processor, comprising:
a processor core having:
a multi-stage pipeline means;
a program counter (PC) means;
a plurality of core register means;
a plurality of flags, including interrupt flags;
an instruction set having:
(iii) at least one branch instruction and an associated delay slot; and
(iv) at least one first instruction disposed in said delay slot, said first instruction adapted to stall said pipeline means upon execution: and
means for storing data adapted to store data, including said interrupt flags, therein;
wherein said processor is adapted to stall said pipeline means using the method comprising the steps of:
storing the settings associated with said interrupt flags in a first of said core register means;
storing a destination address in said first core register means;
temporarily blocking new interrupt requests;
processing all said interrupt flags stored in said means for storing;
executing said branch instruction to branch to said first core register means;
updating said PC means with said destination address;
unblocking said interrupt requests; and
executing said first instruction to cause said pipeline means to stall with no interrupt flags set in said means for storing.

70. A method of operating a pipelined digital processor having a memory, comprising the steps of:
defining a first instruction for stalling the pipeline of said processor upon execution thereof;
providing said first instruction within said pipeline for subsequent decoding;
decoding said first instruction to permit execution of said first instruction;
executing said first instruction;
stalling said pipeline in response to said execution of said first instruction;
disabling said memory in response to said first instruction to reduce power consumption; and
restarting said pipeline and enabling said memory upon the occurrence of a predetermined event.
